(19) United States
(12) Patent Application Publication
(10) Pub. No.: US 2026/0217364 A1
(43) Pub. Date: Jul. 30, 2026

(54) SYSTEM AND METHOD FOR ELECTRONIC LATERAL-DIRECTIONAL STABILITY AUGMETNATION

(71) Applicant: Textron Aviation Inc., Wichita, KS (US)

(72) Inventors: Stephen M. Eddy, Benton, KS (US); Steven G. Hagerott, Wichita, KS (US)

(21) Appl. No.: 19/040,472

(22) Filed: Jan. 29, 2025

(51) Int. Cl. B64C 13/50

(52) U.S. Cl. CPC B64C 13/507

(57) ABSTRACT

A method and pilot assist system for providing electronic lateral and directional stability for an aircraft. The system includes sensors mountable to the aircraft for sensing one or more conditions experienced by the aircraft in real time, as well as at least one servo motor and one or more compensation modules. The at least one servo motor is physically couplable to an aircraft control inceptor and operable to provide reactive forces that work against the pilot or assists the pilot as the pilot manually manipulates the aircraft control inceptor. The one or more compensation modules receive input from the sensors and instruct the at least one servo motor regarding a direction and/or an amount of the reactive forces that the at least one servo motor provides to the aircraft control inceptor based upon the input from the sensors.

### BACKGROUND OF THE INVENTION

Aircrafts with mechanical flight controls typically require some type of mechanical fixes such as springs, interconnects, surface modifications or centering strips to pass all handling qualities requirements in the lateral-directional control axes.

For example, mechanical gearing and/or aerodynamic surface balancing can assist with reducing roll force with speed or roll rate. Furthermore, where there is a need to modify roll force with estimated sideslip and/or to increase rudder force with sides lip to prevent rudder force lightening, aerodynamic fixes or a mechanical aileron-rudder interconnect spring is sometimes used.

Unfortunately, most of these mechanical fixes add weight, cost, and complexity to the manufacturing of the aircraft. In addition to adding weight to the aircraft, some of the mechanical fixes currently used to assist in aircraft stability may need to be calibrated or adjusted further based on individual aircraft loads. Specifically, the way the aircraft is loaded (if the center of gravity of the airplane is forward or aft) can influence the aircraft stability, so an aft-heavy center of gravity may need more augmentation for good handling qualities, as opposed to an aft-heavy center of gravity.

### SUMMARY OF THE INVENTION

Embodiments of the current invention address one or more of the above-mentioned problems and provide a distinct advance in the art of lateral and directional stability augmentation for aircrafts to assist pilots during various flight operations. In one embodiment of the invention, a pilot assist system for providing electronic lateral and directional stability for an aircraft can include sensors, at least one servo motor physically couplable to an aircraft control inceptor (e.g., a lever, wheel, or other pilot aircraft control mechanisms), and one or more competition modules. The sensors may be mountable to the aircraft and may sense one or more conditions experienced by the aircraft in real time. The at least one servo motor provides reactive forces by actuating the aircraft control inceptor, for example. Those reactive forces work against the pilot or assist the pilot as the pilot manually manipulates the aircraft control inceptor. The one or more compensation modules receive input from the sensors and instruct the at least one servo motor regarding a direction and an amount of the reactive forces that the servo motor is to provide to the aircraft control inceptor, based upon the input from the sensors, for optimal aircraft control during flight.

In another embodiment of the invention, a method for providing lateral and directional stability for an aircraft includes a step of receiving, with compensation modules, input from sensors mounted to the aircraft. The sensors sense one or more conditions experienced by the aircraft in real time. The method further includes a step of determining compensation commands via the compensation modules and outputting the compensation commands to a servo control and dynamics system including at least one servo motor. The compensation commands include instructions for the at least one servo motor regarding a direction and an amount of the reactive forces that the at least one servo motor is to provide to an aircraft control inceptor based upon the input from the sensors. The method also includes a step of outputting the compensation commands to the servo control and dynamics system (e.g., to the at least one servo motor). The servo motor or servo motors are physically coupled to the aircraft control inceptor and thus provide reactive forces via the aircraft control inceptor that work against the pilot or assists the pilot as the pilot manually manipulates the aircraft control inceptor.

In yet another embodiment, a method for providing electronic lateral and directional stability for an aircraft includes a step of receiving with compensation modules input from sensors mounted to the aircraft. The sensors sense one or more conditions experienced by the aircraft in real time. The method may also include a step of determining compensation commands via the compensation modules based on input from the sensors, and specifically determining the compensation commands according to at least one of the following: modify roll force based on speed or roll rate, modify roll force with estimated side slip, increase rudder force with side slip to prevent rudder force lightening, level wings of the aircraft to drive the aircraft to level when bank angle is less than a predetermined angle, provide yaw damping in a torque mode, and provide rudder bias force when at least one engine is not operating. The method may also include a step of summing the compensation commands from the compensation modules into a lateral or directional stability compensation command, with the summing performed in a weighted manner in accordance with flight control requirements. The method may further include a step of outputting the lateral or directional stability compensation commands to the servo control and dynamics system including at least one servo motor. The at least one servo motor is physically coupled to an aircraft control inceptor and is configured to provide reactive forces that work against the pilot or assist the pilot as the pilot manually manipulates the aircraft control inceptor.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a flow chart of an electronic lateral-directional stability augmentation system, depicted components and outputs thereof in accordance with some embodiments of the invention;

FIG. 2 is a method flow chart depicting a method of providing electronic lateral and directional stability augmentation for an aircraft in accordance with some embodiments of the invention;

FIG. 3 is a chart depicting example roll rate force assist for a given roll rate in accordance with some embodiments of the invention;

FIG. 4 is a chart depicting example side slip roll centering force assist for a given side slip in accordance with some embodiments of the invention;

FIG. 5 is a chart depicting example rudder force augmentation for a given side slip in accordance with some embodiments of the invention; and

FIG. 6 is a chart depicting example wing leveler centering force assist for a given bank angle in accordance with some embodiments of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

When flying an aircraft, a pilot can put too much force onto the aircraft controls or inceptors, leading to a high roll rate and high loads, and so it is desirable to reduce this roll rate. As described above, prior art methods of accommodating for such issues include mechanical fixes so that the aircraft passes all handling quality requirements, such as in the lateral-directional control axes. However, those mechanical fixes can add undesired weight to the aircraft, can be expensive to implement, and time-consuming to adjust.

Thus, the present invention overcomes the deficiencies of mechanical fixes by using electronic compensation modules instead. Specifically, the present invention uses aircraft sensor signals and applies them to a function and schedule (e.g., the compensation modules) that in turn provide either torque command to a smart servo or position and/or rate commands to fly-by-wire (FBW) surfaces. Inner loops are applied to the servo or surface commands (e.g., via a servo control and dynamics systems) and outer loops are closed via the aircraft state (e.g., aircraft plant) back through the aircraft sensors. In aerospace technology, the inner loop stabilizes the aircraft's dynamics, such as angular velocities and Euler angles. The inner loop controls the aircraft's flight surfaces, such as the ailerons, elevators, and rudder, using sensors and actuators such as the servo described herein. The outer loop controls the aircraft's attitude and speed. The outer loop uses sensors to measure air data, inertial reference, and flight control computers, and sends feedback signals to adjust the aircraft's attitude and speed. The outer loop can also provide additional motion controls, such as speed, altitude, and heading hold.

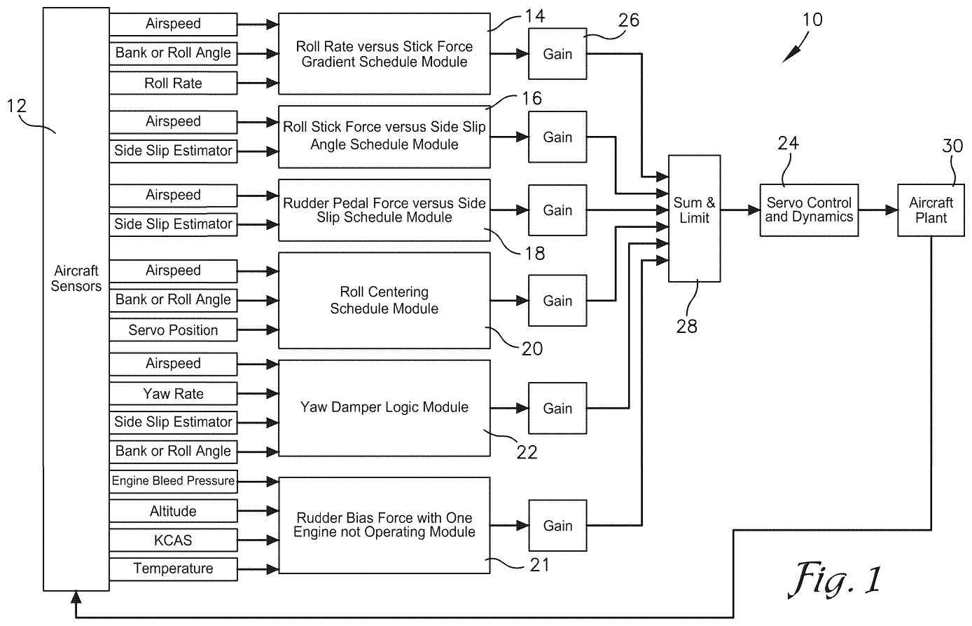

Specifically, as depicted in FIG. 1, an electronic lateral-directional stability augmentation system 10, in accordance with some embodiments of the present invention, includes aircraft sensors 12, compensation modules 14-22, and a servo control and dynamics system 24. Additionally, the system 10 may include various gain circuitry 26 to receive output from the compensation modules 14-22 to boost the signal as needed for additional processing and/or increase or decrease the command authority of the values output by the compensation modules 14-22. The system 10 may also include a signal summing and limiting module 28 executed via hardware circuitry, software, or some combination thereof. The signal summing and limiting module 28 may receive the input from the compensation modules 14-22 and/or the gain circuitry 26 and calculate a desired output to send to the servo control and dynamic system 24. The servo control and dynamics system 24 may include one or more components of the aircraft's autopilot system, for example. Furthermore, the servo control and dynamics system 24 may control various elements of the aircraft plant 30 (e.g., a stick, such as a lever or another inceptor by which a pilot controls the ailerons and elevator of an aircraft). The response of the aircraft plant 30 can in turn impact the inertial and air data subsequently sensed by the aircraft sensors 12, creating a feedback loop for continual adjustments via the compensation modules 14-22 as needed.

The aircraft sensors 12, as defined herein, can include a number of aircraft sensors and systems, such as an air data system and/or an inertial data system of the aircraft. The aircraft sensors can include sensors that determine one or more of the following: altitude, AOA, flap position, KCAS, NZ, phi, pitch rate, pitch trim position, Qbar, Mach number, roll rate, servo position, side slip estimator data, theta, weight estimator data, or yaw rate. For example, the altitude may refer to barometric altitude as measured by an air data system of the aircraft. The AOA is referred to herein as an “angle of attack” and may be measured by AOA vanes or sensors known in the art. The flap position may be measured by system position sensors on the aircraft. The KCAS is referred to herein as “knots calibrated airspeed” and may be measured by the air data system of the aircraft. Furthermore, NZ is referred to herein as normal acceleration and may be measured by an inertial data system of the aircraft. Phi is referred to herein as bank or roll angle. Phi, pitch rate, roll rate, and yaw rate may also be measured by the inertial data system of the aircraft. The pitch trim position is the position of the elevator trim tabs and/or the horizontal stabilizer. Qbar refers to an airspeed measurement (e.g., dynamic pressure as measured by the air data system). Additionally or alternatively, airspeed can be measured as Mach number. The servo position is the position of the output of the control servo. The side slip estimator data may be the calculated aircraft side slip angle based on inertial and air data. Theta is referred to herein as aircraft pitch angle and may be measured by the inertial data system of the aircraft. The weight estimator data may be referred to herein as calculated aircraft weight based on AOA, air, and inertial data.

As depicted in FIG. 1, the compensation modules 14-22 may be executed via hardware, software, or a combination of hardware and software and may include a roll rate versus stick force gradient schedule module 14, a roll stick force versus side slip angle schedule module 16, a rudder pedal force versus side slip (e.g., lateral stability and rudder hinge moment augmentation) schedule module 18, a roll centering schedule module 20, and/or a yaw damper logic module 22. The compensation modules 14-22 allow for electronic augmentation in place of the mechanical fixes to augment stability, either through smart servo technology or via hybrid fly-by-wire (FBW) surfaces.

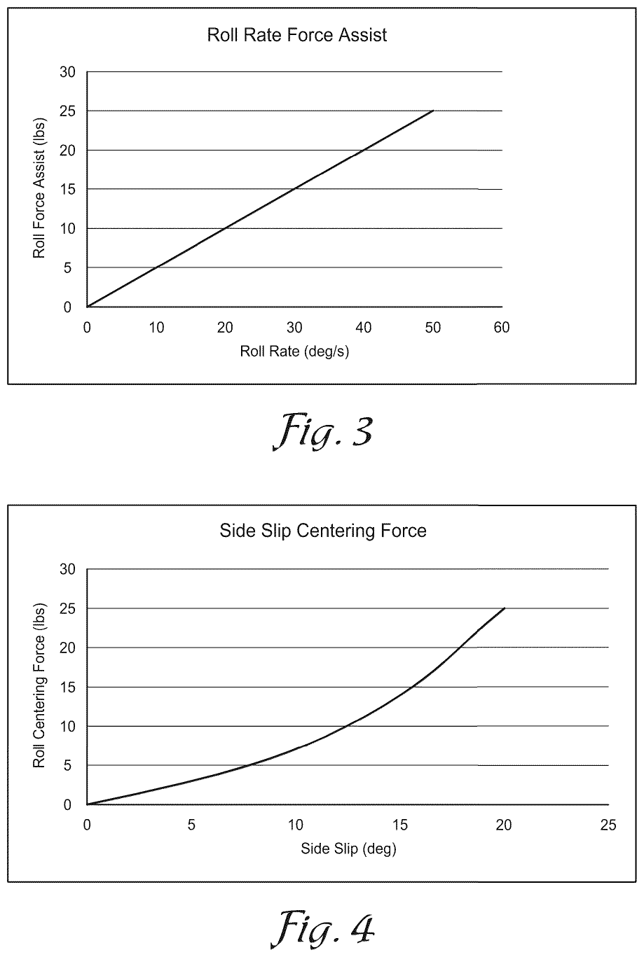

The roll rate versus stick force gradient schedule module 14 may receive input including airspeed (e.g., Qbar), bank or roll angle (e.g., phi), and roll rate, and may be configured to output commands to increase reactive torque based on increasing roll rate to increase stick roll centering force or the aircraft control inceptor's roll centering force. The chart in FIG. 3 depicts exemplary amounts of force assist to be commanded via the roll rate versus stick force gradient schedule module 14 for a given roll rate. However, other roll rate force assist adjustments may be used without departing from the scope of the technology described herein. Furthermore, the roll rate versus stick force gradient schedule module 14 may be configured to output commands to adjust reactive torque based on bank or roll angle and airspeed. This roll rate versus stick force gradient schedule module 14 may operate to reduce roll force with speed or roll rate.

The roll stick force versus side slip angle schedule module 16 may receive input including airspeed (e.g., Qbar) and side slip estimator data, and may be configured to output commands to increase reactive torque based on estimated side slip to increase stick roll centering force or the aircraft control inceptor's roll centering force. Additionally, the roll stick force versus side slip angle schedule module 16 may be configured to output commands to adjust reactive torque based on airspeed. The roll stick force versus side slip angle schedule module 16 may thus be configured to modify roll force with estimated side slip.

The rudder pedal force versus side slip schedule module 18 may receive input including airspeed (e.g., Qbar) and side slip estimator data and may be configured to output commands to increase reactive torque based on increasing estimated side slip to increase rudder pedal centering force. Furthermore, the rudder pedal force versus side slip schedule module 18 may be configured to further output commands to adjust reactive torque based on airspeed. The result of output from the rudder pedal force versus side slip schedule module 18 may thus be increasing rudder force with side slip to prevent rudder force lightening.

The roll centering schedule module 20 may receive input including airspeed (e.g., Qbar), bank or roll angle (e.g., phi), and servo position, and may be configured to schedule a centering torque based on airspeed, bank or roll angle, and servo position to augment the roll centering characteristic of the aircraft. The roll centering schedule module 20 thus acts as a wing leveler to drive the aircraft to level when the bank angle is less than approximately 5 degrees, for example. However, other limits may be used without departing from the scope of the invention as described herein.

The yaw damper logic module 22 may receive input including airspeed (e.g., Qbar), yaw rate, side slip estimator data, and bank or roll angle (e.g., phi), and may be configured to provide Dutch roll damping with torque scheduling and summing, and may further be configured such that the pilot can input a rudder command in parallel with the yaw damper function. In some embodiments, the yaw damper logic module 22 may act as a torque mode yaw damper.

In yet another embodiment, the modules described herein may further include a rudder bias force with one engine not operating module 21 that includes engine bleed pressure, altitude, KCAS, and temperature as inputs, and outputs rudder bias force in a situation where at least one engine is not operating. As noted above, KCAS is referred to herein as “knots calibrated airspeed” and may be measured by the air data system of the aircraft. Additionally or alternatively, other types of airspeed measurements may be used for this module without departing from the scope of the technology described herein.

As noted above, the gain circuitry 26 may boost or otherwise calibrate the output signal of the compensation modules 14-22 as needed for additional processing and/or increase or decrease the command authority of the values output by the compensation modules 14-22. For example, some aircrafts may need more command authority for a damping function or augmentation function than other aircrafts, so the gain circuitry 26 can be used to adjust that authority as needed to tune those commands to the aircraft. In some embodiments, the gain circuitry 26 may be a control-module-output-to-torque-command conversion gain.

The signal summing and limiting module 28 can include hardware circuitry, software, or some combination thereof. The signal summing and limiting module 28 may receive the input from the compensation modules 14-22 and/or the gain circuitry 26 and calculate a desired output to send to the servo control and dynamic system 24, such as by summing the different commands together into a final servo command for the servo control and dynamics system 24 and/or servo motors thereof. Furthermore, the signal summing and limiting module 28 also includes a limiting portion thereof which limits what signal can be output to the servo control and dynamics system 24.

The servo control and dynamics system 24 controls or actuates various elements of the aircraft plant 30 (e.g., a stick or lever, such as an inceptor by which a pilot controls the ailerons and elevator of an aircraft). For example, the servo control and dynamics system 24 includes at least one servo motor or actuator physically couplable to an aircraft control inceptor and configured to provide reactive forces that work against the pilot or assists the pilot as the pilot manually manipulates the aircraft control inceptor. The servo control and dynamics system 24 can include electric motor servos with one or more controllers. For example, the one or more electric motor servos or servo motors can include a roll servo and a yaw servo (e.g., a rudder servo), with compensation instructions related to roll being directed to the roll servo and compensation instructions related to yaw being directed to the yaw servo. In various embodiments, one roll servo and one yaw servo may be used for total lateral-directional functions as described herein. Both the roll and the yaw servos may be physically coupled with the control inceptor (e.g., stick or lever) described herein and/or any combination of inceptors. For example, a control wheel may be used for roll and rudder pedals may be used for yaw in some embodiments.

Additionally or alternatively, some embodiments of the servo control and dynamics system 24 may include a servo kit, a PID gain (e.g., Proportional, Integral, and Derivative control loop for servo tuning), a saturation component, and a torque servo operable to provide actuation of various aircraft plant components and to provide torque and/or current feedback to the servo kit. The servo kit and the PID gain may provide a forward gain or other necessary gains for the servo motors (e.g., the torque servo) of the servo control and dynamics system 24. The saturation component may be used to control saturation limits that are output to command the servo motor or torque servo. The servo motors or torque servos themselves may operate to adjust the aircraft control inceptor described herein and then the output loop from the servo motors or torque servos may also provide a closed loop command for any required adjustments for the servo control and dynamics system 24 based on manual adjustment of the aircraft control inceptor by the pilot or operator thereof. The aircraft control inceptor then controls the aircraft response. Additionally or alternatively, the servo motor or servo motors could be configured to actuate other user controls besides the aircraft control inceptor that likewise impacts the aircraft's physical response, such that the compensation modules 14-22 adjust the response provided when those aircraft controls are manually operated.

The servo control and dynamics system 24 may also include one or more components of the aircraft's autopilot system. In some embodiments, the servo control and dynamics system 24 comprises one or more software modules and/or hardware components of an autopilot servo system. For example, the software modules and/or hardware components of the autopilot servo system can comprise a control system including a processing element, memory elements, and/or communication elements as described below for executing various autopilot commands and/or executing instructions from the signal summing and limiting module and/or the compensation modules described herein.

In some alternative embodiments, note that servo control and dynamics system 24 described herein may be replaced with any servo control system, including any smart servo and/or controllers for fly-by-wire (FBW) surfaces. For example, the output from the compensation modules 14-22 (and/or the gain circuitry or the summing and limiting module) may include a torque command to a smart servo or position and/or rate commands to FBW surfaces.

In use, the servo control and dynamics system 24 may physically actuate and/or provide augmented control force to various elements of the aircraft plant 30 (e.g., the stick or aircraft control lever or control inceptor) based on output from the compensation modules 14-22. The response of the aircraft plant 30 or any components of the aircraft can be in turn sensed by the aircraft sensors 12, creating a feedback loop for continual adjustments via the compensation modules 14-22 as needed. The compensation modules 14-22 described above may be configured for receiving input from the sensors 12 and instructing the servo motor(s) regarding a direction and/or an amount of the reactive forces that the servo motor(s) provide to the aircraft control inceptor based upon the input from the sensors 12.

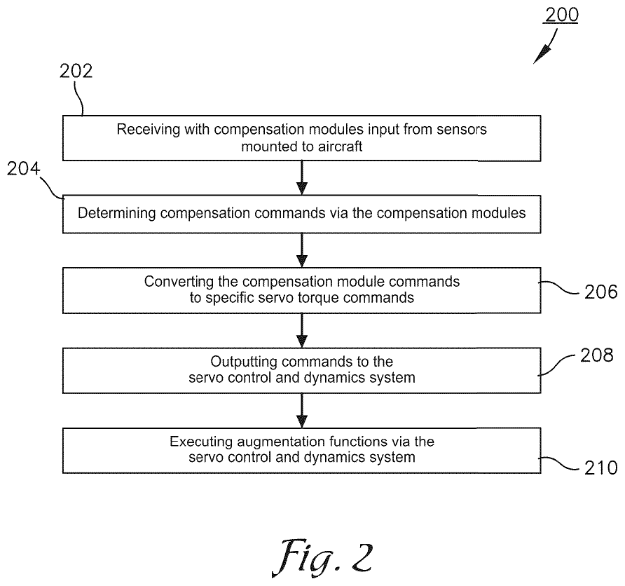

The flow chart of FIG. 2 depicts the steps of an exemplary method 200 for providing lateral and directional stability for an aircraft during manual flight by a pilot in more detail. In some embodiments, various steps may be omitted, or steps may occur out of the order depicted in FIG. 2 without departing from the scope of the technology as described herein. For example, two blocks shown in succession in FIG. 2 may in fact be executed substantially concurrently, or blocks may sometimes be executed in the reverse order depending upon the functionality involved.

For example, the method 200 includes a step of receiving with one or more compensation modules 14-22 input from sensors 12 mounted to the aircraft, as depicted in block 202. As discussed above, the sensors 12 are configured for sensing one or more conditions experienced by the aircraft in real time, such as airspeed, roll rate, or any of the other aircraft variables relevant to flight control dynamics.

The method 200 further comprises determining compensation commands via the one or more compensation modules 14-22, as depicted in block 204. Specifically, the compensation commands include instructions, based upon the input from the sensors 12, for at least one of the servo motors regarding a direction and/or an amount of the reactive force to provide to the aircraft control inceptor or other aircraft plant components controllable by the pilot. The compensation modules 14-22 may include algorithms, functions, tables, schedules, or other instructive computer code that will provide output based on the input received from the sensors.

For example, in some embodiments, the step described in block 204 can be performed with the roll rate versus stick force gradient schedule module 14 and include receiving from the sensors 12 airspeed, bank or roll angle, and/or roll rate and outputting commands to increase reactive torque to the servo motor (e.g., the roll servo) based on increasing roll rate to increase the aircraft control inceptor's roll centering force. Furthermore, the roll rate versus stick force gradient schedule module 14 may adjust reactive torque via the servo motor (e.g., the roll servo) based on bank or roll angle and airspeed to reduce roll force with speed or roll rate. As noted above, the chart in FIG. 3 depicts exemplary amounts of force assist to be commanded via the roll rate versus stick force gradient schedule module 14 for a given roll rate. However, other roll rate force assist adjustments may be used without departing from the scope of the technology described herein.

Furthermore, in some embodiments, the step described in block 204 can additionally or alternatively be performed with the roll stick force versus side slip angle schedule module 16 and include receiving from the sensors 12 airspeed and side slip estimator data and outputting commands to the servo motor (e.g., the roll servo) to increase reactive torque based on the side slip estimator data to increase the aircraft control inceptor's roll centering force. For example, FIG. 4 depicts side slip roll centering force, comparing side slip in degrees with the desired roll centering force compensation. Additionally, the roll stick force versus side slip angle schedule module 16 may output commands to adjust reactive torque based on airspeed.

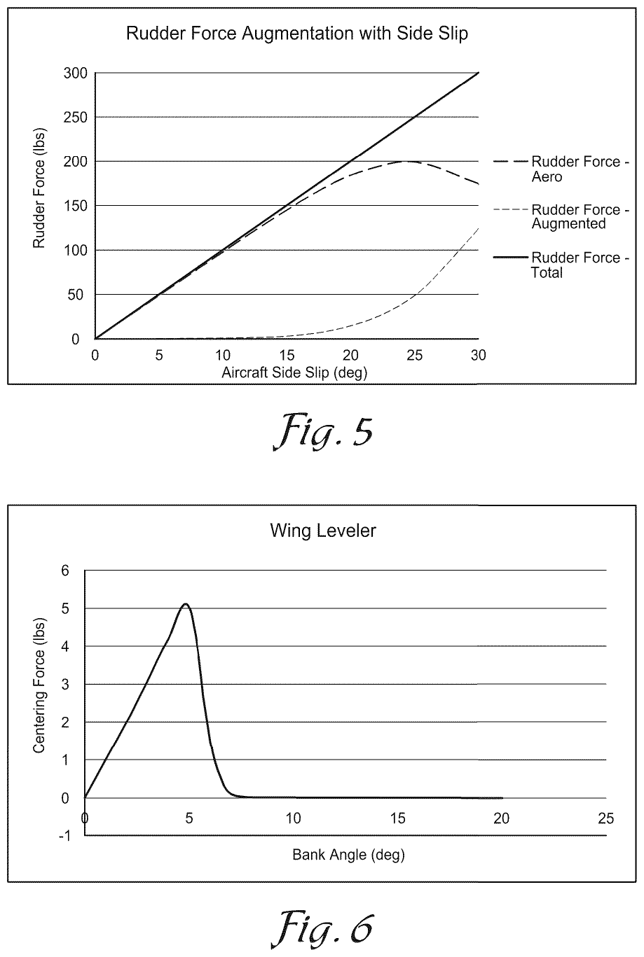

In some embodiments, the step described in block 204 can additionally or alternatively be performed with the rudder pedal force versus side slip schedule module 18 and include receiving from the sensors 12 airspeed and the side slip estimator data and outputting commands to the servo motor (e.g., the roll servo) to increase reactive torque based on sensing increasing estimated side slip to thus increase rudder pedal centering force. For example, the chart in FIG. 5 depicts rudder force augmentation with side slip, comparing an amount of rudder force compensation based on the sensed degree of aircraft side slip. Additionally, the rudder force with side slip schedule module 18 may output commands to the servo motor to adjust reactive torque based on the airspeed. This adjusting of rudder force with side slip may advantageously prevent rudder force lightening.

In various embodiments, the step described in block 204 additionally or alternatively is performed with the roll centering schedule module 20 and includes receiving from the sensors 12 the airspeed, the bank or roll angle, and/or the servo position, and outputting commands to schedule a centering torque based on the airspeed, the bank or roll angle, and/or the servo position to augment the roll centering characteristic of the aircraft (e.g., via the roll servo). For example, the chart in FIG. 6 depicts wing leveler augmentation, comparing bank angle in degrees with the desired centering force compensation. The roll centering schedule module 20 thus acts as a wing leveler to drive the aircraft to level when bank angle is less than approximately 5 degrees, for example. However, other bank angle limits may be used without departing from the scope of the invention as described herein. The wing leveler augmentation helps drive the aircraft to approach a bank angle where the wings are level.

Furthermore, in some embodiments, the step described in block 204 additionally or alternatively is performed with the yaw damper logic module 22 and includes receiving from the sensors airspeed, yaw rate, side slip estimator data, and/or bank or roll angle, and providing Dutch roll damping with torque scheduling and summing, such that the pilot can input a rudder command in parallel with the yaw damper function. In some embodiments, the yaw damper logic module 22 may act as a torque mode yaw damper. Conversely, in traditional systems, a servo is in series and when active has a high backdrive force, so the yaw damper has priority, and the pilot cannot effectively provide a rudder pedal input. However, with the pilot input torque or force input to the control system as disclosed herein, that force input can be summed with the yaw damper.

In one or more embodiments, the step described in block 204 additionally or alternatively is performed with the rudder bias force with one engine not operating module 21 that receives engine bleed pressure, altitude, KCAS, and temperature as inputs from the sensors 12, and outputs rudder bias force via at least one of the servos described herein in a situation where at least one engine is not operating.

In some embodiments, the method includes a step of converting the compensation module commands to specific servo torque commands, as depicted in block 206. For example, as described above, the gain circuitry 26 may be configured to take control module output and convert it to torque command. This torque command may additionally or alternatively include a boost or gain provided thereto from the gain circuitry 26. However, in one or more embodiments, the method step 206 may be omitted without departing from the scope of the technology described herein. In some embodiments, this step 206 may additionally include summing the compensation commands from a plurality of the compensation modules or the specific servo torque commands from the gain circuitry 26 into a lateral and/or directional stability compensation commands. For example, this may be performed with the summing and limiting module 28 based on signals received from the gain circuitry 26. The summing may be performed in a weighted manner in accordance with flight control requirements. Furthermore, in some embodiments, the compensation commands can be weighted, summed, and/or limited by the gain circuitry 26 and/or the summing and limiting module 28 in accordance with control needs of a particular aircraft to determine the lateral and/or directional stability compensation command. The lateral and/or directional stability compensation command provided to the servo control and dynamics system 24 as described below may include, in some embodiments, any one or more of the compensation commands described herein, with or without additional processing such as described in blocks 206 or 208. For example, in some embodiments, the gain circuitry 26 and/or the summing and limiting module 28 can be omitted or replaced with other relevant processing circuitry without departing from the scope of the invention. Specifically, in some alternative embodiments, one of the compensation commands may be fed directly to the servo control and dynamics system 24. Conversely, in some embodiments, the compensation commands may be processed by the gain circuitry 26 and/or the summing and limiting module 28 or other processing circuitry before being fed into the servo control and dynamics system 24 without departing from the scope of the invention.

The method 200 also comprises a step of outputting at least one compensation command to the servo control and dynamic system 24, as depicted in block 208. For example, the at least one compensation command may be any one of the compensation commands from the compensation modules 14-22 described above and/or may be the lateral and/or directional stability compensation command, determined based on one or more of the compensation commands from the compensation modules 14-22. As noted above, the servo control and dynamics system 24 includes at least one servo motor (e.g., the roll servo and the yaw servo). Those servo motors are physically coupled to the aircraft control inceptor and provide reactive forces that work against the pilot or assist the pilot as the pilot manually manipulates the aircraft control inceptor, for example. In some embodiments, output from one or more of the roll rate versus stick force gradient schedule module 14, the roll stick force versus side slip angle schedule module 16, the rudder pedal force versus side slip schedule module 18, and the roll centering schedule module 20 may be combined and/or processed (e.g., at the signal summing and limiting module 28) and output to the roll servo to control roll feedback provided to the aircraft control inceptor and experienced by the pilot operating the aircraft control inceptor. In other embodiments, output from the yaw damper logic module 22 may be sent (e.g., via the signal summing and limiting module 28) to the yaw servo to control yaw feedback provided to the aircraft control inceptor and experienced by the pilot operating the aircraft control inceptor. While the embodiments above describe the servo control and dynamics system 24 receiving torque commands for a smart servo, additionally or alternatively, control signals output from the compensation modules 14-22 may provide position and/or rate commands to fly-by-wire (FBW) surfaces.

In some embodiments, the method 200 further comprises executing augmentation functions via the servo control and dynamics system 24, as depicted in block 210. For example, the augmentation functions may include one or more of pitch, roll, yaw, and throttle via the servo control and dynamics system 24. Additionally or alternatively, augmentation functions may include one or more autopilot functions. For example, the compensation modules 14-22 may utilize autopilot systems to meet handling requirements/provide the necessary control feedback or augmentation functions to the pilot (e.g., via servo force applied to the aircraft control inceptor) during flight instead of mechanical fixes such as springs, interconnects, surface modifications or centering strips used in prior art aircrafts in order to pass all handling qualities requirements in the lateral-directional control axes. However, an independent system and servo not associated with the autopilot system may be used for the methods described herein without departing from the technology described herein.

Note that the compensation modules described herein are primarily directed toward lateral or directional stability and producing lateral or directional stability compensation commands. However, other compensation modules may output other types of compensation commands without departing from the scope of the invention. For example, U.S. Patent Application No. ______, entitled SYSTEM AND METHOD FOR ELECTRONIC PTICH STABILITY AUGMENTATION, also filed on ______ and incorporated by reference herein in its entirety, describes compensation modules directed toward pitch stability. Thus, compensation modules for pitch stability may be used along with the compensation modules for lateral and/or directional stability described herein without departing from the scope of the invention. Furthermore, any of the curves in FIGS. 3-6 may be modified as needed to meet desired handling qualities of any specific aircraft without departing from the scope of the technology as described herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments, such as the compensation modules and other modules described herein, are described as including logic or a number of routines, subroutines, applications, functions, algorithms, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, compensation modules, or the like, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules (such as the compensation modules herein) that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A pilot assist system for providing electronic lateral and directional stability for an aircraft, the system comprising:
sensors mountable to the aircraft and configured for sensing one or more conditions experienced by the aircraft in real time;
at least one servo motor physically couplable to an aircraft control inceptor and configured to provide reactive forces to flight surfaces of the aircraft that work against the pilot or assists the pilot as the pilot manually manipulates the aircraft control inceptor; and
one or more compensation modules configured for receiving input from the sensors and instructing the at least one servo motor regarding a direction and an amount of the reactive forces that the at least one servo motor provides to the aircraft control inceptor based upon the input from the sensors.

2. The system of claim 1, further comprising a servo control and dynamics system including the at least one servo motor, wherein the servo control and dynamics system is further configured to execute autopilot functions including one or more of pitch, roll, yaw, and throttle.

3. The system of claim 1, wherein the at least one servo motor includes a roll servo and a yaw servo.

4. The system of claim 3, wherein the one or more compensation modules includes a roll rate versus stick force gradient schedule module that receives airspeed, bank or roll angle, and roll rate from the sensors and is configured to output commands to increase reactive torque via the at least one servo motor based on increasing roll rate to increase the aircraft control inceptor's roll centering force.

5. The system of claim 4, wherein the roll rate versus stick force gradient schedule module is configured to adjust reactive torque via the at least one servo motor based on bank or roll angle and airspeed to reduce roll force with speed or roll rate.

6. The system of claim 3, wherein the one or more compensation modules include a roll stick force versus side slip angle schedule module that receives the airspeed and side slip estimator data and is configured to output commands to the at least one servo motor to increase reactive torque based on the side slip estimator data to increase the aircraft control inceptor's roll centering force.

7. The system of claim 6, wherein the roll stick force versus side slip angle schedule module is further configured to output commands to the at least one servo motor to adjust reactive torque based on airspeed.

8. The system of claim 3, wherein the one or more compensation modules include a rudder pedal force versus side slip schedule module that receives from the sensors the airspeed and the side slip estimator data and is configured to output commands to the at least one servo motor to increase reactive torque based on increasing estimated side slip to increase rudder pedal centering force.

9. The system of claim 8, wherein the rudder pedal force versus side slip schedule module is further configured to output commands to the at least one servo motor to adjust reactive torque based on the airspeed.

10. The system of claim 3, wherein the one or more compensation modules include a roll centering schedule module that receives input including airspeed, bank or roll angle, and servo position, and is configured to output commands to schedule a centering torque based on airspeed, bank or roll angle, and servo position to augment the roll centering characteristic of the aircraft.

11. They system of claim 3, wherein the one or more compensation modules include a yaw damper logic module that receives input including airspeed, yaw rate, side slip estimator data, and bank or roll angle, and is configured to provide Dutch roll damping with torque scheduling, and is further configured such that the pilot can input a rudder command in parallel with the yaw damper function.

12. The system of claim 1, wherein the one or more compensation modules are configured to instruct the at least one servo motor to react according to at least one of the following:
reduce roll force with speed or roll rate,
modify roll force with estimated side slip,
increase rudder force with side slip to prevent rudder force lightening,
level wings of the aircraft to drive the aircraft to level when bank angles are less than a predetermined angle,
provide yaw damping in a torque mode, and
provide rudder bias force when at least one engine is not operating.

13. A method for providing electronic lateral and directional stability for an aircraft, the method comprising:
receiving with compensation modules input from sensors mounted to the aircraft, wherein the sensors are configured for sensing one or more conditions experienced by the aircraft in real time;
determining compensation commands via the compensation modules, wherein the compensation commands include instructions for at least one servo motor based upon the input from the sensors; and
outputting the compensation commands to a servo control and dynamics system including the at least one servo motor, wherein the at least one servo motor is physically coupled to an aircraft control inceptor and is configured to, based on the compensation commands, provide reactive forces to flight surfaces of the aircraft that work against the pilot or assists the pilot as the pilot manually manipulates the aircraft control inceptor.

14. The method of claim 13, further comprising executing autopilot functions including one or more of pitch, roll, yaw, and throttle via the servo control and dynamics system.

15. The method of claim 13, further comprising receiving with at least one of the compensation modules airspeed, bank or roll angle, and roll rate from the sensors and outputting commands to increase reactive torque to the at least one servo motor based on increasing roll rate to increase roll centering force of the aircraft control inceptor and to adjust reactive torque via the at least one servo motor based on bank or roll angle and airspeed to reduce roll force with speed or roll rate.

16. The method of claim 13, further comprising receiving with at least one of the compensation modules airspeed and side slip estimator data from the sensors and outputting commands to the at least one servo motor to increase reactive torque based on the side slip estimator data to increase the roll centering force of the aircraft control inceptor and to adjust reactive torque based on airspeed.

17. The method of claim 13, further comprising receiving with at least one of the compensation modules airspeed and the side slip estimator data from the sensors and outputting commands to the at least one servo motor to increase reactive torque based on sensing increasing estimated side slip to thus increase rudder pedal centering force, and outputting commands to the at least one servo motor to adjust reactive torque based on the airspeed.

18. The method of claim 13, further comprising receiving with at least one of the compensation modules, from the sensors, airspeed, bank or roll angle, and servo position, and outputting commands to schedule a centering torque based on the airspeed, the bank or roll angle, and the servo position to augment the roll centering characteristic of the aircraft.

19. The method of claim 13, further comprising receiving with at least one of the compensation modules, from the sensors, airspeed, yaw rate, side slip estimator data, and bank or roll angle, and providing Dutch roll damping with torque scheduling, such that the pilot can input a rudder command in parallel with the yaw damper function.

20. A method for providing electronic lateral and directional stability for an aircraft, the method comprising:
receiving with one or more compensation modules input from sensors mounted to the aircraft, wherein the sensors are configured for sensing one or more conditions experienced by the aircraft in real time;
determining compensation commands via the one or more compensation modules based on input from the sensors, wherein the one or more compensation modules are configured to determine the compensation commands according to at least one of the following:
reduce roll force based on speed or roll rate,
modify roll force with estimated side slip,
increase rudder force with side slip to prevent rudder force lightening,
level wings of the aircraft to drive the aircraft to level when bank angles are less than a predetermined angle,
provide yaw damping in a torque mode, and
provide rudder bias force when at least one engine is not operating;
summing the compensation commands from a plurality of the compensation modules into a lateral or directional stability compensation command, wherein the summing is performed in a weighted manner in accordance with flight control requirements; and
outputting the lateral or directional stability compensation commands to a servo control and dynamics system including at least one servo motor, wherein the at least one servo motor is physically coupled to an aircraft control inceptor and is configured to provide reactive forces via actuation of flight surfaces of the aircraft that work against the pilot or assists the pilot as the pilot manually manipulates the aircraft control inceptor.
